(19) United States
(12) Patent Application Publication
(10) Pub. No.: US 2009/0277227 A1
(43) Pub. Date: Nov. 12, 2009

(54) GLASS MELTING IN THE PRESENCE OF SULPHUR

(75) Inventors: Philippe Pedeboscq, Mareil Marly (FR); Remi Jacques, Estrees Saint Denis (FR); Anne Berthereau, Challes Les Eaux (FR)

Correspondence Address: OBLON, SPIVAK, MCCLELLAND MAIER & NEUSTADT, L.L.P., 1940 DUKE STREET, ALEXANDRIA, VA, 22314, US

(73) Assignee: SAINT-GOBAIN TECHNICAL FABRICS EUROPE, Chambery (FR)

(21) Appl. No.: 12/439,930

(22) PCT Filed: Sep. 3, 2007
(86) PCT No.: PCT/FR07/51866

§ 371 Date: Mar. 4, 2009

(30) Foreign Application Priority Data
Sep. 7, 2006 (FR) 0653616

(51) Int. Cl. C03B 37/07; C03B 3/00

(52) U.S. Cl. 65/380; 65/29.17

(57) ABSTRACT

The invention relates to a process for manufacturing a glass by melting, at more than 1300° C., batch materials comprising silica and an alkali or alkaline-earth metal sulfate, characterized in that a sulfide is added to the batch materials in order to reduce the height of foam at the surface of the bath of liquid glass at more than 1300° C. The invention reduces the formation of foam at the surface of the glass and improves the heat exchanges between the overhead burners and the glass bath. The invention is particularly suitable for glass intended to be fiberized.

The invention relates to melting glass, especially glass that can be converted into fibers, in the presence of sulfide as a foam-reducing agent.

A sulfate is commonly used as a silica fluxing agent within the context of preparing glass by melting. The sulfate facilitates melting of the silica and reduces the proportion of unmelted silica grains in the final glass, known as “batch stones”. The presence of an alkali metal oxide such as Na₂O (in soda-lime-silicate glass) makes the sulfate soluble in the molten batch. This is why this sulfate decomposes slightly (low production of SO₃) during the melting process. Thus, a vitrifiable batch comprising 0.6% by weight of initial sulfate may result in a glass that finally contains 0.3% by weight of residual sulfate.

Certain applications, such as certain electronic components, are incompatible with the presence of alkali metal oxide in the glass. In particular, standards impose less than 2% by weight of alkali metal oxide.

In the case of a vitrifiable composition containing little or no alkali metal oxide (less than 2% by weight, or even less than 1% by weight), the sulfate is not dissolved in the glass matrix and partially decomposes during the melting process around 1400° C., creating a considerable amount of foam. It is observed that for this type of glass there are two peaks for formation of gaseous SO₃, one around 1000° C., of little importance, at the same time as the reaction of the sulfate with the silica, and the other, of great importance, above 1300° C., generally around 1350 to 1400° C. which corresponds to a thermal decomposition of the sulfate (without any particular reaction with another element).

The production of a soda-lime-silicate glass does not give rise to any foaming via decomposition of the sulfate above 1300° C. It has already been proposed to use a mixture of sulfate and sulfide as a refining agent for soda-lime-silicate glass. The refining agent is used to increase the volume of the bubbles produced during melting in order to make them rise more rapidly, without creating new ones. Some of the gaseous SO₂ being used to swell the bubbles to be eliminated is emitted during the melting phase via reaction between the sulfate and the silica, the sulfide acting as an accelerator for this reaction. The refining is important for the soda-lime-silicate glass which is then converted to flat or hollow glass. The glass intended for fiberizing (by passing through holes in fiberizing spinners or bushings) are not particularly refined and the manufacturing furnaces are not followed by a refining compartment. For glass intended to be fiberized, a poor glass-refining quality may cause breakage of the filaments, especially fine filaments. The formula usually followed by the glass manufacturers is to incorporate into the glass batch a mixture of sulfate and of a reducing element such as carbon. In any case, the refining quality required for the fiberized glass is lower than that for a flat glass. This alkali or alkaline-earth metal sulfate also acts as a flux. Thus, for the production of glass fibers, it has never been proposed to use a sulfate/sulfide mixture as, on the one hand, the refining quality does not demand it and, on the other hand, sulfides are expensive.

During the melting of the glass batch, especially E-glass, a film of foam is formed on the surface of the bath. This foam is a true insulator slowing down the heat exchange between the overhead burners and the glass. It is not possible to greatly increase the power of the overhead burners since the thermal limit of the furnace structure (degradation temperature of the refractories) is rapidly reached. Thus, the presence of foam makes it necessary to compensate for the deficit in the transmission of heat by the overhead burners toward the glass bath by increasing the heating power supplied in the bath itself, under the foam, for example using electrodes submerged in the liquid glass. However, electric heating, even when its yield is excellent, is very expensive compared to heating via combustion of fossil material, for a given amount of energy transmitted to the glass. It is desired, therefore, to minimize as much as possible the amount of electrical energy required by using as much fossil energy as possible for the overhead burners. This occurs with reduction and if possible removal of the foam. Furthermore, for furnaces where the electric boosting is at the maximum of that which the installation allows, the reduction of the foam thickness makes it possible to increase the furnace output. The invention solves the abovementioned problems by reducing or eliminating the formation of foam at the surface of the glass above 1300° C.

The invention therefore relates to a process for manufacturing a glass, especially one intended to be fiberized, by melting batch materials, at more than 1300° C., which comprise silica and an alkali or alkaline-earth metal sulfate, characterized in that a sulfide is added to the batch materials in order to reduce the formation of foam (which may be measured by its height) at more than 1300° C. The invention relates to glass which foams at more than 1300° C. by decomposition of the sulfate so that a melting process identical to that of the invention but without the addition of sulfide results in a foam height greater than that obtained with the process according to the invention.

The sulfide is that of a metal such as Na, Ca, Zn, Mo or Cd. The sulfide may therefore be chosen from the following sulfides: Na₂S, CaS, ZnS, MOS₂, CdS. Of course, the sulfide may be a mixture of several metal sulfides. The addition of sulfide to the batch materials may be accompanied by the addition of other materials as long as these other materials are compatible with the melting process and the composition of the final glass. It has been found that the slags derived from blast furnaces within the context of steel manufacture may form materials very well suited to the glass and may furthermore form an advantageous sulfide source. A slag is, from the start, a partially vitrified material, generally containing oxides such as CaO, Al₂O₃, SiO₂ and MgO and melting quite easily, which is advantageous. Thus, the sulfide may be introduced into the batch materials in the form of slag.

A standard slag composition is, for example:

| | |
|---|---|
| SiO₂ | 35% by weight |
| Al₂O₃ | 11% by weight |
| CaO | 40% by weight |
| MgO | 8% by weight |
| Na₂O | 0.5% by weight |
| SO₃ | 2% by weight |

The introduction of the sulfide in the form of slag generally gives an energy gain for melting the glass, said gain mainly stemming from the heating of the gases. This is because the slag, by nature causes very little loss on ignition. The slag also gives a gain in reaction heat due to the fact that it is partially vitrified.

The material added to the glass batch as a sulfide source (a slag or the sulfide itself preferably has a relatively fine particle size and preferably is especially free of particles larger than 400 μm and even free of particles larger than 300 μm and even more preferably free of particles larger than 200 μm. The reactivity of the sulfide with the sulfate of the glass batch is specifically linked to its particle size. Ideally, the sulfide must be free of large refractory grains (such as those made of silicon carbide, corundum, etc.), grains which melt with difficulty during the melting and therefore are sources of breakages during fiberizing.

According to the invention, the amount of sulfide introduced is sufficient so that the foam height is significantly reduced, or even totally eliminated, compared to the same melting process without the addition of sulfide. A person skilled in the art is used to expressing the amounts of sulfate or of sulfide as SO₃ equivalents by weight or in moles. This is the amount of SO₂ (or initial SO₃ equivalent) which may be generated by the compound after oxidation. For example, one mole of Na₂S is equivalent to one mole of SO₃ as the oxidation of one mole of Na₂S results in the formation of one mole of SO₂ (Na₂S+3/2O₂→SO₂+Na₂O). Similarly, one mole of MOS₂ corresponds to two moles of SO₃. One mole of Na₂SO₄ corresponds to one mole of SO₃. Thus, the amount of sulfide expressed as SO₃ is generally less than 50%, and preferably less than 30% and generally less than 25% of the amount of alkali or alkaline-earth metal sulfate, especially Na₂SO₄ or CaSO₄, expressed as SO₃ (in moles or by weight, it amounts to the same thing here). The amount of sulfide expressed as SO₃ is generally greater than 5 mol %, and preferably greater than 10 mol % of the amount of alkali or alkaline-earth metal sulfate expressed as SO₃.

The alkali or alkaline-earth metal sulfate may be sodium sulfate or calcium sulfate. The amount of alkali or alkaline-earth metal sulfate added to the batch materials is generally greater than 0.03% (expressed by weight of SO₃) of the total mass of final glass and is generally less than 1.2% (expressed by weight of SO₃) of the total weight of final glass. This amount generally ranges from 0.1 to 1.2, and preferably from 0.2 to 1% (expressed by weight of SO₃) of the total mass of final glass.

In the absence of sulfide, the melting glass (especially E-, C- or S-glass according to the meaning of the standard D 578:2000) in question in the present invention forms, above 1300° C., a foam with a height of at least 1.2 cm, even at least 2 cm, even at least 3 cm, or even at least 5 cm. The presence of the sulfide makes it possible to reduce this height by at least 10% or even by at least 20%, or even by at least 30%. It will be recalled that a foam is an agglomeration of gas bubbles separated by a thin film of liquid having a thickness much smaller than the diameter of the bubbles. The maximum foam heights were compared, knowing that the foam height may vary during a discontinuous melting process.

The glass in question in the present invention is that which gives rise to significant formation of foam by decomposition of alkali or alkaline-earth metal sulfate at more than 1300° C. during the melting process. In particular, it may be E-glass according to the meaning of the ASTM D 578:2000 standard, AR glass (that is to say alkali-resistant glass) according to the meaning of the DIN 1259-1 standard, C-glass according to the meaning of the D 578:2000 standard and S-glass according to the meaning of the D 578:2000 standard. All these types of glass are silicate glass having a silica content that is generally less than 70% by weight and more generally less than 69% by weight. They can be fiberized by known means when they are passed through orifices (extrusion through bushings, extrusion/attenuation by rotating fiberizing spinners, etc.). It is possible, in particular, to convert them to fibers directly after melting and without a refining compartment between the melting furnace and the fiberizing device.

Thus, the invention also relates to a process for continuously preparing glass fibers comprising the melting of said glass in a melting furnace via the melting process according to the invention, then the fiber conversion of said glass in a fiberizing device, without solidification of the glass between the furnace and the fiberizing device. In particular, this process does not require any refining compartment between the furnace and the fiberizing device.

### EXAMPLES

A 0.4 m² furnace was provided for melting the batch materials. This furnace was equipped with eight oxygen/combustible gas burners supplying in total from 90 to 130 kW and two electric boosting zones supplying in total 12 kW.

Table 1 gives the batch materials introduced into the furnace in order to finally obtain 100 kg of glass. The amounts introduced exceed 100 kg due to gaseous losses.

TABLE 1

| | Ex 1 | | | |
|---|---|---|---|---|
| | (reference) | Ex 2 | Ex 3 | Ex 4 |
| Silica | 30.2 | 30.2 | 29.5 | 28.3 |
| Kaolin | 43.8 | 43.8 | 42.3 | 38.4 |
| Colemanite | 12.6 | 12.6 | 12.5 | 12.0 |
| Limestone | 31.0 | 31.0 | 29.1 | 23.9 |
| Raw dolomite | 6.1 | 6.1 | 4.1 | |
| Sodium sulfate | 0.99 | 0.99 | 0.99 | 0.50 |
| Borax pentahydrate | 0.35 | 0.35 | 0.41 | 1.00 |
| Slag | | | 4.7 | 15.0 |
| Molybdenum disulfide | | 0.055 | | |
| Total (kg) | 125.0 | 125.1 | 123.6 | 119.1 |
| Sulfides (wt %) | 0 | 0.06 | 0.09 | 0.3 |

In any case, the total content of alkali metal oxide (Na₂O+K₂O+Li₂O) was 0.9 wt %.

The tests were carried out at with a constant output of 15 kg/hour, at a constant crown temperature (1580° C.) and at a constant floor temperature (1350° C. in the middle of the furnace). From example 1 to example 4, the sulfide content was increased and the energy control in terms of burner power and electric power was modified in order to keep the crown and floor temperatures constant. The power of the overhead burners was first controlled to keep the crown temperature constant, then, the electric power was controlled to reach the desired floor temperature. Table 2 gives the results.

TABLE 2

| | Ex 1 | | | |
|---|---|---|---|---|
| | (reference) | Ex 2 | Ex 3 | Ex 4 |
| Sulfate SO₃ | 0.6 | 0.6 | 0.6 | 0.3 |
| Sulfide nature | — | MoS₂ | Slag | Slag |
| Sulfide SO₃ | 0 | 0.06 | 0.09 | 0.3 |
| Burner power (kW) | 110 | 115 | 120 | 98 |
| Electrode power (kW) | 6.5 | 4.5 | 4.5 | 10.5 |
| Foam height | 15 mm | 10 mm | 10 mm | 20 mm |

It was observed that a suitable amount of sulfide resulted in a 50% reduction of the foam height and consequently in a 30% reduction of the electric power required. On the other hand, too high an amount of sulfide (Ex.4) produced the reverse effect.

Table 3 gives the calculated energy gain over the heat for production of the glass due to the introduction of slag taking into account the heat of fusion of the slag.

TABLE 3

| | per kg of molten glass | | |
|---|---|---|---|
| | Ex 1 | | |
| | (reference | Ex 3 | Gain |
| Heat of reaction (kJ) | 696 | 683 | 1.9% |
| Heating of the gases (except | 379 | 364 | 4.0% |
| water) (kJ) | | | |
| Vaporization of water (kJ) | 184 | 179 | 2.3% |
| Heating of the glass (kJ) | 1555 | 1555 | 0.0% |
| TOTAL (kJ) | 2813 | 2780 | 1.2% |

The introduction of the slag therefore gave an energy gain of 1.2%. This gain came mainly from heating of the gases due to the fact that the slag had, by nature, a very low loss on ignition. There is also a gain in the heat of reaction due to the fact that the slag was partially vitrified.

1. A process for manufacturing a glass by melting, at more than 1300° C., batch materials comprising silica and an alkali or alkaline-earth metal sulfate, wherein a sulfide is added to the batch materials in order to reduce the height of foam at the surface of the bath of liquid glass at more than 1300° C.

2. The process as claimed in claim 1 wherein the sulfate is sodium sulfate or calcium sulfate.

3. The process as claimed in claim 1, wherein the amount of sulfate added to the batch materials ranges from 0.03 to 1.2% by weight of SO₃ of the total mass of final glass.

4. The process as claimed in, claim 3, wherein the amount of sulfate added to the batch materials ranges from 0.2 to 1% by weight of SO₃ of the total mass of final glass.

5. The process as claimed in claim 1, wherein the final glass contains less than 2% by weight of alkali metal oxide.

6. The process as claimed in claim 5, wherein the final glass contains less than 1% by weight of alkali metal oxide.

7. The process as claimed in claim 1, wherein the sulfide is a sulfide of a metal chosen selected from the group consisting of Na, Ca, Zn, Mo, and Cd.

8. The process as claimed in claim 1, wherein the amount of sulfide is sufficient to reduce the foam height at more than 1300° C. compared to the same process without sulfide.

9. The process as claimed in claim 1, wherein the amount of sulfide expressed as SO₃ is less than 50% of the amount of alkali or alkaline-earth metal sulfate expressed as SO₃.

10. The process as claimed in claim 9, wherein the amount of sulfide expressed as SO₃ is less than 30% of the amount of alkali or alkaline-earth metal sulfate expressed as SO₃.

11. The process as claimed in claim 1, wherein the amount of sulfide expressed as SO₃ is greater than 5% of the amount of alkali or alkaline-earth metal sulfate expressed as SO₃.

12. The process as claimed in claim 11, wherein the amount of sulfide expressed as SO₃ is greater than 10% of the amount of alkali or alkaline-earth metal sulfate expressed as SO₃.

13. The process as claimed in claim 1, wherein the sulfide is introduced in the form of slag.

14. The process as claimed in claim 1, wherein the sulfide is introduced in the form of a material that is free of particles larger than 300 μm.

15. The process as claimed in claim 1, wherein the final glass is an E-, C- or S-type glass according to the meaning of the ASTM D 578:2000 standard or an AR glass according to the meaning of the DIN 1259-1 standard.

16. A process for continuously preparing glass fibers comprising the melting of said glass in a melting furnace via the process of claim 1 then the fiber conversion of said glass in a fiberizing device, without solidification of the glass between the furnace and the fiberizing device.

17. The process as claimed in claim 16, wherein no refining compartment is found between the furnace and the fiberizing device.

18. The process as claimed in claim 1, wherein the final glass is an E-glass, C-glass or S-glass according to the meaning of the ASTM D 578:2000 standard or an AR glass according to the meaning of the DIN 1259-1 standard.
